(19) United States
(12) Patent Application Publication
(10) Pub. No.: US 2026/0351013 A1
(43) Pub. Date: Nov. 5, 2026

(54) Method and Apparatus for Processing Road Traffic

(71) Applicant: Robert Bosch GmbH, Stuttgart (DE)

(72) Inventor: Leichen Wang, Shanghai (CN)

(21) Appl. No.: 19/658,582

(22) Filed: Apr. 26, 2026

(30) Foreign Application Priority Data
Apr. 30, 2025 (CN) 2025 1057 0687.0

(51) Int. Cl. G06V 20/56; G01C 21/00; G01C 21/36; G06T 7/246; G06V 10/774; G06V 10/82

(52) U.S. Cl. CPC G06V 20/588; G01C 21/3602; G01C 21/3822; G06T 7/246; G06V 10/774; G06V 10/82; G06T 2207/20072; G06T 2207/20081; G06T 2207/20084; G06T 2207/30172; G06T 2207/30236; G06T 2207/30241; G06T 2207/30256

(57) ABSTRACT

A method for processing road traffic includes (i) based on an image, detecting the trajectory of an object contained in the image, (ii) generating a first road traffic feature graph based on at least one of the object's trajectory and the image, (iii) generating a lane centerline of the lane based on the first road traffic feature graph, and (iv) generating a lane topology based on the lane centerline.

This application claims priority under 35 U.S.C. § 119 to application no. CN 2025 1057 0687.0, filed on Apr. 30, 2025 in China, the disclosure of which is incorporated herein by reference in its entirety.

The present application relates to the field of autonomous driving, and more specifically, to a method and apparatus for determining road traffic topological relationships, a method and apparatus for predicting vehicle trajectories, and a method and apparatus for training a neural network (NN) model.

### BACKGROUND

Accurate modeling of complex traffic scenarios is a critical component of Advanced Driver Assistance Systems (ADAS) for performing correct planning and control. Lane topology reasoning aims to understand road lane scenarios and to present feasible driving routes in autonomous driving. This requires detecting lanes in the scenario and further reasoning about their topological relationships.

In existing lane topology prediction neural networks, training the network requires lane topology labels as ground truth data. However, obtaining such ground truth data is extremely costly, and scaling the annotation process for large datasets is both laborious and inefficient. Therefore, improved lane topology prediction methods and corresponding training methods are needed to reduce the requirement for lane topology label data while maintaining the accuracy of lane topology prediction.

### SUMMARY

The following introduction is provided in order to introduce selected concepts in a simple manner, and these concepts will be further described in the detailed description below. The introduction is not intended to highlight the key or necessary features of the claimed subject matter, nor is it intended to limit the scope of the claimed subject matter.

To address the above problems, the present application provides a novel lane topology prediction method and a corresponding NN model training method. Furthermore, it provides a novel vehicle future trajectory prediction method and a corresponding NN model training method. By employing the method of the present application, the dependence on fully annotated lane topology data is reduced, thereby solving the challenges of limited labeled data and specific domains while maintaining the accuracy of lane topology prediction.

According to one aspect of the present application, a method for processing road traffic is provided, comprising: based on an image, detecting the trajectory of an object contained in the image; generating a first road traffic feature graph based on at least one of the object's trajectory and the image; generating a lane centerline of the lane based on the first road traffic feature graph; and generating a lane topology based on the lane centerline.

According to one aspect of the present application, a method for training a neural network (NN) model for processing road traffic is provided, comprising: based on boundary labels of a lane in a first training set, determining a lane centerline pseudo-label of the lane, wherein the first training set comprises an image and the boundary labels of the lane contained in the image; generating a lane topology pseudo-label based on the lane centerline pseudo-label; processing the image in the first training set by the method described in embodiments of the present disclosure to predict the lane centerline and lane topology of the lane contained in the image and trajectory of an object contained in the image; and updating the learning parameters of the NN model based on the lane centerline pseudo-label, the lane topology pseudo-label, the predicted lane centerline, and the predicted lane topology.

According to one aspect of the present application, an apparatus for processing road traffic is provided, comprising: a detection module for, based on an image, detecting the trajectory of an object contained in the image; a first road traffic feature extraction module for generating a first road traffic feature graph based on at least one of the object's trajectory and the image; a centerline prediction module for generating a lane centerline of the lane based on the first road traffic feature graph; and a topology prediction module for generating a lane topology based on the lane centerline.

According to one aspect of the present application, an apparatus for training an NN model for processing road traffic is provided, comprising: a lane centerline pseudo-label generation module, configured to, based on boundary labels of a lane in a first training set, determine a lane centerline pseudo-label of the lane, wherein the first training set comprises an image and the boundary labels of the lane contained in the image; a lane topology pseudo-label generation module, configured to generate a lane topology pseudo-label based on the lane centerline pseudo-label, wherein the NN model processes the image in the first training set by the method described in embodiments of the present disclosure to predict the lane centerline and lane topology of the lane contained in the image; and an update module, configured to update the learning parameters of the NN model based on the lane centerline pseudo-label, the lane topology pseudo-label, the predicted lane centerline, and the predicted lane topology.

According to one aspect of the present application, a processing apparatus is provided, comprising: one or more processors; and one or more memories storing computer-executable instructions that, when executed by the one or more processors, perform the operations of the method described in embodiments of the present application.

According to one aspect of the present application, a machine-readable storage medium is provided that stores executable instructions that, when executed, cause one or more processors to perform operations of the method described in embodiments of the present application.

According to one aspect of the present application, a computer program product is provided, which comprises executable instructions that, when executed, cause one or more processors to perform operations of the method described in embodiments of the present application.

According to the technical solution of the present disclosure, the information about road structure provided by the ground truth data of the lane boundaries and the information about the dynamic changes of the road environment provided by the dynamic object trajectories make the lane topology prediction model more adaptable to new environments. Thus, while using easily obtainable lane boundaries as weak supervision signals to train the NN model, the performance of the model prediction is guaranteed. This effectively overcomes the problem of requiring a large amount of topologically labeled data for training in the prior art and reduces the need for expensive and labor-intensive fully labeled data. Other advantages of the technical solution of the present disclosure will be described below.

### BRIEF DESCRIPTION OF THE DRAWINGS

The nature and advantages of the content of the present application may be further implemented by referring to the following accompanying drawings. In the drawings, similar components or features may have the same reference signs.

FIG. 1 is a schematic diagram of road traffic topological relationships according to one embodiment.

FIGS. 2A to 2C respectively are block diagrams of an apparatus for determining road traffic topological relationships according to one embodiment.

FIG. 3A is an example schematic diagram of trajectory tracking according to one embodiment.

FIG. 3B is an example schematic diagram of lane boundaries according to one embodiment.

FIG. 3C is an example schematic diagram of a lane centerline according to one embodiment.

FIG. 3D is an example schematic diagram of labeled lane boundaries according to one embodiment.

FIGS. 4 and 5 respectively are schematic diagrams of a process for training a neural network model according to one embodiment.

FIG. 6 is a flow chart of a method for processing road traffic according to one embodiment.

FIG. 7 is a flowchart of a method for training an NN model according to one embodiment.

FIG. 8 is a block diagram of an apparatus for processing road traffic according to one embodiment.

FIG. 9 is a block diagram of an apparatus for training an NN model according to one embodiment.

FIG. 10 is a block diagram of a processing apparatus according to one embodiment.

### DETAILED DESCRIPTION

The subject matter described herein will now be discussed with reference to exemplary embodiments. It should be understood that discussions about these embodiments are provided to aid those skilled in the art in better understanding and thereby implementing the subject matter described herein rather than limiting the scope of protection, applicability, or examples described in the patent claims. Changes may be made to the functions and arrangements of the elements discussed without departing from the scope of protection of the content of the present application. Various processes or components may be omitted, substituted, or added in the various examples as needed. For example, the described method may be performed in a different order than that described, and various steps may be added, omitted, or combined. In addition, features described in relation to some examples may also be combined in other examples.

As used herein, the term “comprising” and its variations are open terms, which mean “including but not limited to.” The term “based on” indicates “at least partially based on.” The terms “one embodiment” and “an embodiment” indicate “at least one embodiment.” The term “another embodiment” indicates “at least one other embodiment.” The terms “first,” “second,” etc. may refer to different or same objects. Other definitions, whether explicit or implied, may be included below. Unless explicitly stated in the context, the definition of one term is consistent throughout the Description.

FIG. 1 is a schematic diagram of road traffic topological relationships according to one embodiment.

Lane lines 110 are traffic markings that exist in the real world and are used to divide the lanes on a road. In this document, lane lines 110 are collectively referred to as lane boundaries to distinguish them from lane centerlines. The lane topology indicated by label 120 represents the relationships between lane segments, which do not actually exist in the real world. For example, the four arrows shown by label 120 represent the relationships between a lane segment on the lower right and two lane segments on the upper right and two lane segments on the lower right, respectively, such as a drivable relationship. The relationships between lane segments can be called lane topology relationships or road traffic topological relationships. For example, this lane topology can be represented by an adjacency matrix, where each node in the adjacency matrix represents a lane segment, and the matrix elements between two nodes represent the relationship between them. For example, element 1 indicates that there is a drivable relationship between the two, and 0 indicates that there is no drivable relationship between the two.

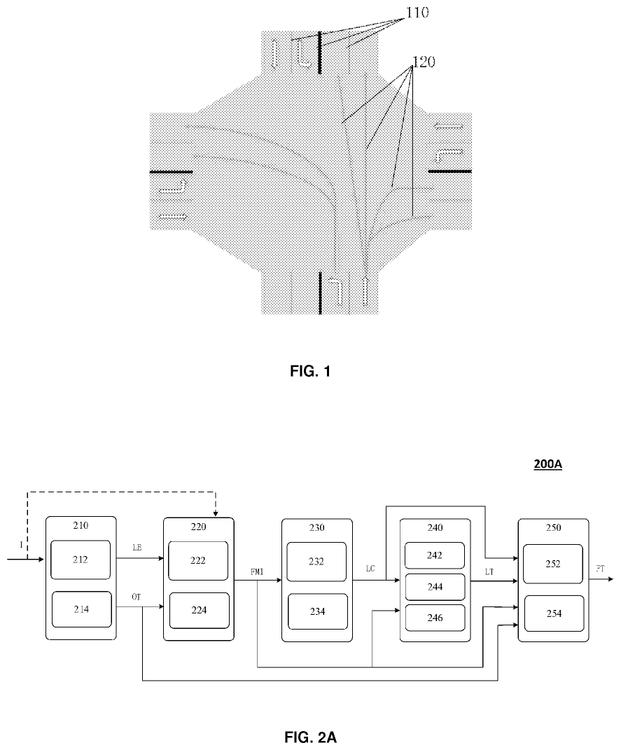

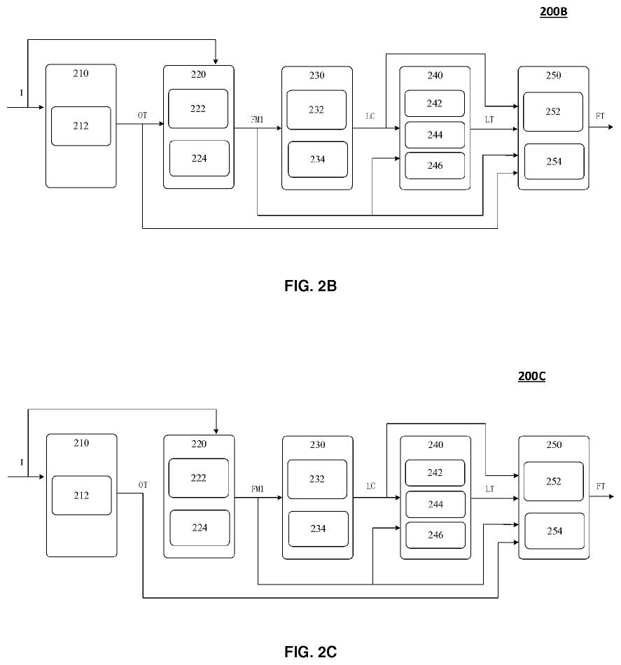

FIG. 2A is a block diagram of an apparatus 200A for determining road traffic topological relationships according to one embodiment.

The apparatus 200A comprises a detection module 210, a road traffic feature extraction module 220, a lane centerline generation module 230, a topology generation module 240, and an optional vehicle trajectory prediction module 250. It will be appreciated that the apparatus 200A may comprise other modules; FIG. 2A only shows modules relevant to the present embodiment. In one example, these modules may be deployed in a vehicle. For example, the vehicle may have autonomous driving capabilities and may determine road traffic topological relationships to perform autonomous driving. In another example, some or all of these modules may be deployed in a server, wherein the vehicle and the server can communicate to exchange data.

The detection module 210 may obtain a road traffic image I as input. For example, the road traffic image I may comprise a multi-view image acquired from an image sensor on the vehicle, which contains multiple images of the panoramic view around the vehicle, such as six images acquired by six image sensors on the vehicle. Alternatively, the image I may be one or more images corresponding to partial angles around the vehicle, such as one or more images acquired by one or more image sensors located in front of the vehicle. Alternatively, the image I may be an image acquired by other types of sensors, such as a three-dimensional depth image acquired by a lidar. Alternatively, the image I may be a bird's-eye view (BEV) image, for example, by converting image data acquired by image sensors and/or sensors such as lidar into a BEV image in BEV coordinates.

The detection module 210 detects the trajectory OT of an object contained in the input image I and the boundary LE of a lane contained in the image. For example, the detection module 210 comprises a trajectory tracking module 212 and a lane boundary detection module 214. The trajectory tracking module 212 detects the trajectory of an object contained in the image I, and the lane boundary detection module 214 detects the boundary of a lane contained in the image I.

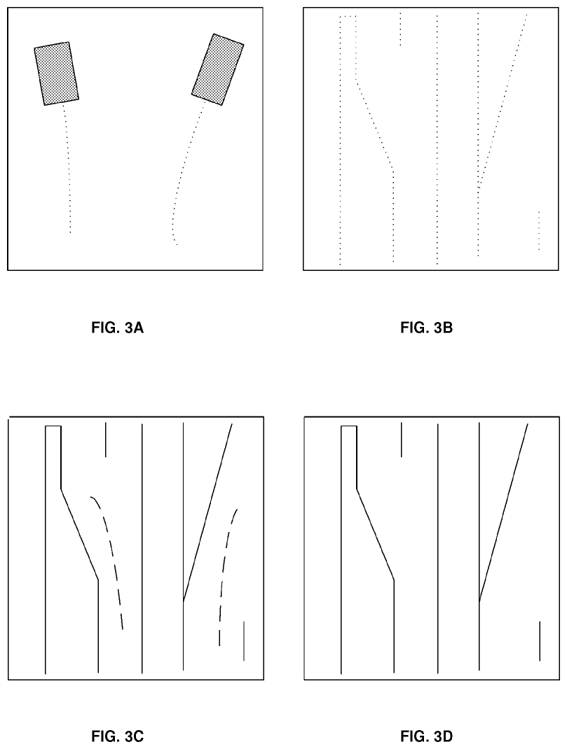

The trajectory tracking module 212 tracks objects such as vehicles and pedestrians moving on the lane, and the obtained object trajectories provide dynamic information about the road traffic. For example, the trajectory tracking module 212 may track the trajectory of each object over a period of time based on a series of images I that are continuous in time. FIG. 3A shows an example of trajectory tracking, which comprises the trajectories of two objects. For example, in the case of tracking the trajectory over 5 seconds at a frequency of 10 Hz, a tracking trajectory comprises 50 coordinate points (or sampling points), and the two object trajectories in the example comprise, for example, trajectory identifiers (IDs) and coordinate points. It is understood that the trajectory may also comprise other information, such as trajectory type, velocity at each coordinate point, acceleration, etc. It is understood that the trajectory tracking module 212 may be implemented using any object tracking method.

The lane boundary detection module 214 detects the boundary of a lane contained in the image I, and the obtained lane boundary provide static information about the road traffic. For example, the lane boundary detection module 214 detects lane boundary in the current image I. FIG. 3B shows an example of lane boundary, which comprises multiple lane boundaries. For example, a lane boundary comprises coordinate points. It is understood that lane boundaries may also comprise other information, such as lane boundary type, lane boundary ID, etc. It is understood that the lane boundary detection module 214 may be implemented using any object tracking method.

The road traffic feature extraction module 220 generates a road traffic feature representation FM1 based on the object trajectory OT and the lane boundary LE. This feature representation FM1 may also be called a road traffic feature graph or feature sequence FM1. The road traffic feature graph FM1 is a spatial representation of the road environment that comprises static information (lane boundary) and dynamic information (object trajectory). For example, the road traffic feature graph FM1 may be a tensor of shape (d1, d2, dc), which represents a d1×d2 grid with dc channels. For example, d1=d2=16, dc=512. In this example, each of the 16×16 grid points comprises a 512-dimensional feature vector.

In one embodiment, as shown in FIGS. 3A and 3B, the object trajectory OT and lane boundary LE are comprised in the BEV graph as input to the road traffic feature extraction module 220. For example, as shown in FIG. 2A, the BEV graph as input to the road traffic feature extraction module 220 comprises information about the object trajectory OT and lane boundary LE but does not comprise the input image. As another example, as shown by the dashed arrow from input I to feature extraction module 220 in FIG. 2A, the BEV graph as input to the road traffic feature extraction module 220 may comprise information about the input image I and information about the object trajectory OT and lane boundary LE. For example, the object trajectory OT and lane boundary LE are superimposed on the BEV graph of the input image I to obtain the BEV graph as input to the road traffic feature extraction module 220. It is understood that the object trajectory OT and lane boundary LE may be used as input to the road traffic feature extraction module 220 in any suitable manner, and are not limited to the method of BEV graph described above.

In one embodiment, the road traffic feature extraction module 220 comprises a feature extraction module 222 and a feature output module 224. The feature extraction module 222 processes the input object trajectory OT and lane boundary LE to generate a feature graph FM2, which has a spatial dimension d1×d2×dc and represents high-level spatial features extracted from the object trajectory OT and lane boundary LE. In one embodiment, the feature extraction module 222 may be implemented by a convolutional neural network (CNN). For example, the feature extraction module 222 may be implemented by a backbone network ResNet18, which is a CNN network for feature extraction with the ability to extract hierarchical high-level spatial features. It is understood that any suitable backbone network can be used to implement the feature extraction module 222.

The feature output module 224 processes the feature graph FM2 to obtain a feature graph FM1 that is more suitable for downstream tasks. In one embodiment, the feature output module 224 may be implemented using a multilayer perceptron (MLP) network. It is understood that any suitable neural network can be used to implement the feature output module 224.

The lane centerline generation module 230 generates a lane centerline LC based on the road traffic feature graph FM1. FIG. 3C shows an example of a lane centerline LC, as shown by the dashed line in the figure. For example, a lane centerline is a collection of lane centerline segments, and each lane centerline segment may comprise coordinates. It is understood that a lane centerline segment may also comprise other information, such as lane centerline segment ID, lane centerline segment type, lane centerline segment length, and sampling points contained in the lane centerline segment.

In one embodiment, the lane centerline generation module 230 comprises a convolution module 232 and a centerline prediction module 234. For example, the convolution module 230 may comprise multiple convolutional layers for predicting a heatmap of the lane centerline. In one example, taking a 16×16×512 feature graph FM1 as an example, the convolution module 230 may comprise three convolutional layers. Convolutional layer 1 has a 3×3 kernel, a stride of 1, and padding of 1, and reduces the number of channels in feature graph FM1 from 512 to 256, thus outputting a 16×16×256 feature graph FMc1. Convolutional layer 2 has a 3×3 kernel, a stride of 1, and padding of 1, and reduces the number of channels in feature graph FMc1 from 256 to 128, thus outputting a 16×16×128 feature graph FMc2. Convolutional layer 3 has a 3×3 kernel, a stride of 1, and padding of 1, and convolutional layer 1 reduces the number of channels in feature graph FMc2 from 128 to 1, thus outputting a 16×16×1 feature graph FMc3, which serves as a heatmap of the predicted lane centerline. It is understood that the convolution module 232 may be implemented using any suitable structure.

The centerline prediction module 234 determines the lane centerline LC based on the heatmap FMc3. The heatmap FMc3 has the same spatial dimension of 16×16 as the input feature graph FM1 and is a single-channel two-dimensional matrix, where higher element values correspond to higher confidence in the lane centerline position. For example, the centerline prediction module 234 may process the heatmap FMc3 using the non-maximum suppression (NMS) method to extract the coordinates of the lane centerline segment. In one example, an extracted coordinate point may represent a lane centerline segment. Further processing may be performed based on the extracted lane centerline segment. For example, curve fitting may be performed on the extracted coordinate points to generate a smooth lane centerline. For a lane centerline segment, the coordinates of the sampling points corresponding to the lane centerline segment may be sampled on the fitted lane centerline, and used as the sampling point set of the lane centerline, which may be used as an attribute of the lane centerline segment. Other attributes, such as ID and length, may also be determined for the lane centerline segment.

The topology generation module 240 generates the lane topology LT based on the road traffic feature graph FM1 and the lane centerline LC. The lane topology LT represents the relationships between lane segments, such as the drivable relationship between two lanes. For example, if the lane centerline LC comprises n lane segments, the lane topology LT determined by the topology generation module 240 may comprise a lane segment-lane segment matrix of size n×n. For example, this lane segment-lane segment matrix may be

$$A = {( \begin{matrix}0 & 1 & ⋯ & 0 \\ ⋮ & ⋮ & ⋱ & ⋮ \\ 1 & 0 & ⋯ & 0\end{matrix} )}_{n \times n} ,$$

where the element Aᵢⱼ=1 in the matrix indicates that lane segment j can be entered from lane segment i, and the element Aᵢⱼ=0 indicates that lane segment j cannot be entered from lane segment i. It is understood that the lane topology LT does not necessarily have to be represented in matrix form; as long as it can represent the corresponding lane segment-lane segment relationships, it can be represented in any suitable form.

In one embodiment, the topology generation module 240 is implemented using a Graph Convolutional Network (GCN). In the illustrated example, the topology generation module 240 comprises a graph construction module 242, a graph convolution module 244, and a topology output module 246. The graph construction module 242 constructs a graph containing nodes and edges based on the lane centerline LC and the feature graph FM1, where each node corresponds to a lane centerline segment, and each edge corresponds to a relationship between a pair of lane centerline segments. In one embodiment, each node may be identified by the coordinates of the lane centerline segment corresponding to that node, or each node may have its ID and be associated with the coordinates of the lane centerline segment corresponding to that node. The node features of each node may be extracted from the feature graph FM1 to obtain the node feature matrix

$$H = {( \begin{matrix}{H}_{1} \\ ⋮ \\ {H}_{n}\end{matrix} )}_{n \times d c}$$

of the graph, where n is the number of nodes and dc is the feature vector dimension. Taking a 16×16×512 feature graph FM1 as an example, the feature vector of each node has a dimension of 512. This means that each node carries rich feature information and can well characterize the features of the lane centerline at that location. In one embodiment, spatial proximity may be used to assign a portion of the feature graph FM1 to the corresponding node. For example, region of interest (ROI) pooling may be used to construct the feature vector of each node from the feature graph FM1. Taking node i corresponding to lane segment i as an example, based on the principle of spatial proximity, the feature vector corresponding to the region adjacent to the lane segment i is selected from the 16×16 feature vectors of the feature graph FM1. For example, the feature vectors corresponding to region i and multiple surrounding regions of lane segment i are pooled to obtain the node feature vector of node i, which is a 1×512-dimensional feature vector in this example. By aggregating the values in the feature graph FM1 to calculate the feature vector of each node, each node may summarize the information of its corresponding region, thereby more effectively representing the features of the lane centerline segment in the graph structure.

In one embodiment, an initial adjacency matrix

$$A = {( \begin{matrix}{A}_{11} & {A}_{12} & ⋯ & {A}_{1 n} \\ ⋮ & ⋮ & ⋱ & ⋮ \\ {A}_{n 1} & {A}_{n 1} & ⋯ & {A}_{n n}\end{matrix} )}_{n \times n}$$

may be constructed based on the distance between nodes. For example, the distance between each pair of nodes may be determined based on the coordinates of the lane centerline segments corresponding to each node, such as Euclidean distance, Manhattan distance, etc. The adjacency matrix may be constructed based on a function of distance. For example, a linear function may be used, setting the weight Aᵢⱼ of the edge between nodes i and j in the adjacency matrix A to the reciprocal of the distance dᵢⱼ between them, i.e.,

$${A}_{i j} = \frac{1}{{d}_{i j}} .$$

For example, a Gaussian function may be used, setting the weight Aᵢⱼ of the edge between nodes i and j in the adjacency matrix A to the Gaussian function of the distance dᵢⱼ between them, i.e.,

$${A}_{i j} = {e}^{- {( \frac{{d}_{i j}}{σ} )}^{2}} ,$$

where σ is a hyperparameter. In one example, the adjacency matrix obtained above may be normalized to obtain an initial adjacency matrix A. It is understood that other functions may also be used to determine the relationship elements Aᵢⱼ between nodes i and j in adjacency matrix A.

After the graph construction module 242 constructs a graph represented by the node feature matrix H and the adjacency matrix A, the graph convolution module 244 performs graph convolution operations on the graph to update the node features based on the information of neighboring nodes and capture the topological information of how the lane centerline segments are connected.

According to one embodiment, the GCN of the graph construction module 242 comprises L GCN layers, where each GCN convolutional layer may be represented as: H^{(l+1)}=σ(ÂH⁽ⁱ⁾W^{(l)}), where H⁽¹⁾ is the node feature matrix H constructed by the graph construction module 242, A is the normalized adjacency matrix based on the adjacency matrix A constructed by the graph construction module 242, W^{(l)} is the weight matrix of the l-th GCN layer, and σ is the activation function. After GCN processing, the node features obtained by graph convolution are

$${H}^{( L + 1 )} = {( \begin{matrix}{H}_{1}^{L + 1} \\ ⋮ \\ {H}_{n}^{L + 1}\end{matrix} )}_{n \times d c} .$$

It is understood that any suitable graph convolution processing method can be used to perform the graph convolution operations of the graph convolution module 244. For example, during the processing at each layer, the adjacency matrix Â may be fixed or updated accordingly, such as updating the adjacency matrix Â based on H^{(l+1)} output at l-th layer.

The topology output module 246 generates the topology LT between lane centerline segments based on the feature graph H^{(L+1)} output by the graph convolution module 244, which can be represented as matrix

$$LT = A = {( \begin{matrix}0 & 1 & ⋯ & 0 \\ ⋮ & ⋮ & ⋱ & ⋮ \\ 1 & 0 & ⋯ & 0\end{matrix} )}_{n \times n} .$$

In one embodiment, the topology output module 246 may be implemented using a multilayer perceptron (MLP) network. It is understood that any suitable neural network can be used to implement the topology output module 246. In one embodiment, in addition to outputting the topology LT, the topology output module 246 may also output other information, such as the lane segment type (left-turn lane, right-turn lane, straight lane, etc.). The attributes of the lane centerline may be further updated based on the information output by the topology output module 246, for example, updating the topology information and type information of lane centerline segment i. For example, the topology information may comprise one or more subsequent lanes that can be entered from lane centerline segment i and one or more preceding lanes that can enter the lane centerline segment i.

In one embodiment, the vehicle trajectory prediction module 250 predicts the future trajectory of the vehicle based on the lane topology LT, the object trajectory OT, and the road traffic feature graph FM1. In one embodiment, as indicated by the arrows from module 230 to module 250, the attributes of the lane centerline LC are updated based on the lane topology LT as described above to obtain an updated lane centerline LC, such that the attributes of the updated lane centerline segment comprise the lane topology information output by the topology generation module 240. The vehicle trajectory prediction module 250 predicts the future trajectory of the vehicle based on the lane centerline LC containing the lane topology information LT, the object trajectory OT, and the road traffic feature graph FM1.

In one embodiment, the vehicle trajectory prediction module 250 comprises an attention module 252 and a vehicle trajectory output module 254. In one embodiment, the attention module 252 performs cross-attention processing based on the road traffic feature graph FM1, the lane centerline LC containing lane topology information LT, and the object trajectory OT. For example, the attention module 252 generates a query feature sequence or query matrix (Q) based on the road traffic feature graph FM1, a key feature sequence or key matrix (K) based on the lane centerline LC, and a value feature sequence or value matrix (V) based on the object trajectory OT. As described above, the road traffic feature graph FM1 is a feature sequence of dimension (d1×d2, dc). In other words, it comprises d1×d2 dc-dimensional feature vectors. The lane centerline LC comprises n lane segments, and the lane segment feature sequence FMIc of dimension (n, dk) is obtained by encoding the n lane segments. The object trajectory OT comprises n1 objects, each object comprising trajectory identifier, trajectory sampling points, etc., and the object trajectory feature sequence FMot of dimension (n1, dv) is obtained by encoding the trajectories of the n1 objects. For each feature sequence FM1, FMIc, and FMot, they are projected onto the Q, K, and V matrices through a learnable linear layer: Q=Wq·FM1, K=Wk·FMIc, and V=Wv·FMot. It is understood that the generated Q, K, and V matrices have the same dimension d, which may be equal to, for example, FM1 having dimension dc, or any suitable value. Attention module 252 performs cross-attention processing on the Q, K, and V matrices to obtain a cross-attention feature graph FMc with dimension (d1×d2, d). In one embodiment, the number of lane segments n comprised in the lane centerline LC differs from the number of objects n1 comprised in the object trajectory OT; therefore, the number of vectors in the two matrices is aligned when generating the K and V matrices. Alignment can be achieved through various methods, such as interpolating, padding, or repeating the V matrix to make the number of vectors in the V matrix the same as that in the K matrix. Alternatively, interpolating, padding, or repeating can be performed on both the V and K matrices to make the number of vectors in the Q, K, and V matrices the same. It is understood that the attention module 252 may comprise multiple attention layers, each iteratively performing cross-attention processing, and may comprise other necessary operations in addition to the cross-attention operations described above. It is understandable that attention processing of the road traffic feature graph FM1, lane centerline LC and object trajectory OT by attention module 252 can be implemented in any appropriate manner.

The vehicle trajectory output module 254 generates the vehicle's future trajectory FT based on the feature graph FMc output by the attention module 252. For example, the vehicle trajectory output module 254 generates the vehicle's future trajectory FT based on the feature graph FMc output by the attention module 252 and the information of the lane segment where the vehicle is located. For example, the future trajectory FT comprises the coordinates of predicted sampling points over a future period of time. For example, the coordinates of sampling points in the next 5 seconds; when 10 sampling points are comprised per second, the future trajectory comprises the coordinates of 50 sampling points in the next 5 seconds. In one embodiment, the vehicle trajectory output module 254 may be implemented using a multilayer perceptron (MLP) network. It is understood that any suitable neural network can be used to implement the vehicle trajectory output module 254.

FIG. 2B is a block diagram of an apparatus 200B for determining road traffic topological relationships according to one embodiment. The same components in 2A and 2B are represented by the same reference signs.

In the embodiment of FIG. 2B, the detection module 210 comprises a trajectory tracking module 212, but does not comprise the lane boundary detection module 214 in the embodiment of FIG. 2A. The road traffic feature extraction module 220 receives the trajectory OT of the object and the input image I, and generates a road traffic feature graph FM1 based on the trajectory OT and the input image I. For example, the BEV graph as input to the road traffic feature extraction module 220 may contain information of the input image I and information of the object trajectory OT. For example, the object trajectory OT is superimposed on the BEV graph of the input image I to obtain the BEV graph as input to the road traffic feature extraction module 220. Other operations in the embodiment of FIG. 2B are the same as those in the embodiment shown in FIG. 2A, and will not be described again.

FIG. 2C is a block diagram of an apparatus 200C for determining road traffic topological relationships according to one embodiment. The same components in 2A and 2C are represented by the same reference signs.

In the embodiment of FIG. 2C, the object trajectory OT generated by the detection module 210 is not used as input to the road traffic feature extraction module 220. The road traffic feature extraction module 220 receives the input image I and generates a road traffic feature graph FM1 based on image I. Other operations in the embodiment of FIG. 2C are the same as those in the embodiment shown in FIG. 2B, and will not be described again.

FIG. 4 is a schematic diagram of a process for training a neural network model according to one embodiment. The training process is described in FIG. 4 using the model structure shown in FIG. 2B as an example. The process described also applies to the model structures shown in FIGS. 2A and 2C.

During training, the ground truth data used as supervision data is the lane boundary GT-LE in image I. This ground truth lane boundary GT-LE, shown in FIG. 3D, represents the ground truth location, or label location, of the lane boundary in image I. The candidate pseudo-label determination module 410 calculates an initial candidate for the lane centerline pseudo-label PGT-LC based on the lane boundary GT-LE. For example, the midpoint between two lane boundaries may be used as an initial candidate for the lane centerline pseudo-label PGT-LC. For example, the midpoint may be obtained by interpolation between each pair of sampling points of the two lane boundaries. It is understood that any appropriate matching method can be used to determine the midpoint between pairs of sampling points of the two lane boundaries.

In the pseudo-label generation stage, modules 210 to 250 perform operations similar to those described above in conjunction with FIGS. 2A to 2C, especially FIGS. 2A and 2B, except that the ground truth lane boundary GT-LE corresponding to image I is used as input to the road traffic feature extraction module 220. Accordingly, the lane centerline generation module 230 generates a pseudo-label PGT-LC for the lane centerline, the topology generation module 240 generates a pseudo-label PGT-LT for the lane topology, and the optional vehicle trajectory prediction module 250 generates a pseudo-label PGT-FT for the future trajectory of the vehicle.

During the inference phase, modules 210 to 250 perform the operations described above in conjunction with FIGS. 2A to 2C. Unlike the pseudo-label generation phase, the ground truth lane boundary GT-LE corresponding to image I is not used as input to the road traffic feature extraction module 220. Accordingly, the lane centerline generation module 230 generates a lane centerline LC, the topology generation module 240 generates a lane topology LT, and the optional vehicle trajectory prediction module 250 generates a pseudo-label FT for the vehicle's future trajectory.

The loss module 420 determines the loss L based on the pseudo-labels PGT-LC, PGT-LT, and PGT-FT and the corresponding predicted values LC, LT, and FT. According to one embodiment, in the initial stage of training, the loss may be determined based on the initial candidate of the lane centerline pseudo-label PGT-LC output by the candidate pseudo-label determination module 410, and after the initial stage, the loss is determined based on the pseudo-label PGT-LC of the lane centerline generated by the lane centerline generation module 230.

According to one embodiment, in order to generate an accurate lane centerline pseudo-label and align it with the dynamic object trajectory, the centerline-related loss may comprise boundary loss L_{LC1}, and optionally dynamic trajectory consistency loss L_{LC2} and/or alignment loss L_{LC3}.

The boundary loss L_{LC1} uses weak supervision from the ground truth lane boundary GT-LE to ensure that the predicted centerline is close to the midpoint between the left and right lane boundary lines. For example, the boundary loss may be calculated using binary cross-entropy (BCE), L_{LC1}=Σ_{i,j}BCE(LC(i,j),PGT_LC(i,j)), where LC(i,j),PGT_LC(i j) are the coordinates of the sampling points of the predicted centerline and the pseudo-label centerline, respectively.

The dynamic trajectory consistency loss L_{LC2} aligns the predicted centerline with the dynamic object trajectory. For example, the dynamic trajectory consistency loss may be calculated based on the distance between the predicted centerline and the dynamic object trajectory, L_{LC2}=ΣₜDist(LC(t),OT(t)), where LC(t) is the predicted centerline at time t, and OT(t) is the dynamic object trajectory at time t output by the detection module 210.

The goal of the alignment loss L_{LC3} is to align dynamic object trajectory with the lane centerline when they are not perfectly aligned. This loss takes into account the spatial transformation required to align the dynamic object trajectory with the lane centerline. For example, a spatial transformation network or an optical flow network may be used to compute the alignment loss, L_{LC3}=Σ_{i,j}∥LC(i,j)−Transform(OT(i,j))∥, where Transform( ) represents the spatial transformation network or the optical flow network.

According to one embodiment, the loss related to lane topology may be calculated using binary cross-entropy (BCE),

$${L}_{L T} = \text{} - \text{} \frac{1}{{N}^{2}} {\sum }_{i = 1}^{N} {\sum }_{j = 1}^{N} ( {PGT\_LT}_{i j} \cdot log ( L {T}_{i j} ) + ( 1 - {PGT\_LT}_{i j} ) \cdot log ( 1 - {LT}_{i j} ) ) ,$$

where LTᵢⱼ and PGT_LTᵢⱼ are the adjacency matrix element values of the predicted lane topology and the pseudo-label lane topology, respectively.

According to one embodiment, the loss associated with the vehicle trajectory may be calculated using the least mean square error (MSE),

$${L}_{F T} = \frac{1}{N} {\sum }_{i = 1}^{N} {( {PGT\_x}_{i} - {FT\_x}_{i} )}^{2} + {( {PGT\_y}_{i} - {FT\_y}_{i} )}^{2} ,$$

where (PGT_xᵢ,PGT_yᵢ)) are the coordinates of the pseudo-label PGT-FT of the vehicle's future trajectory at time step i, and (FT_xᵢ,FT_yᵢ) are the coordinates of the predicted vehicle's future trajectory at time step i.

In one embodiment, the loss module 420 may determine the loss L based on the above-mentioned loss components. For example, the loss L may be the sum of the above-mentioned loss components. It is understood that the loss L may comprise a portion of the above-mentioned losses, or it may comprise other loss components.

In one embodiment, the components 210 to 250 of the NN model shown in FIG. 4 may be trained together or separately. For example, the lane centerline generation module 230 may be trained first based on a loss related to the lane centerline, and then the topology generation module 240 may be trained individually or additionally based on a loss related to the lane topology, or modules 230 and 240 may be trained jointly. Then, the vehicle trajectory prediction module 250 may be trained individually or additionally based on a loss related to the future trajectory of the vehicle, or modules 230 to 250 may be trained jointly.

The NN model shown in FIG. 4 learns to generate a pseudo-label under weak supervision of lane boundary GT-LE, so this NN model can also be called a pseudo-label generator. For example, the NN models shown in FIGS. 2A and 2B may be used as pseudo-label generators. The pseudo-label generated by this pseudo-label generator can also be used to train other neural network (NN) models for generating lane centerlines, lane topologies, and/or future trajectories of vehicles. For example, they can be used to train the NN model shown in FIG. 2C.

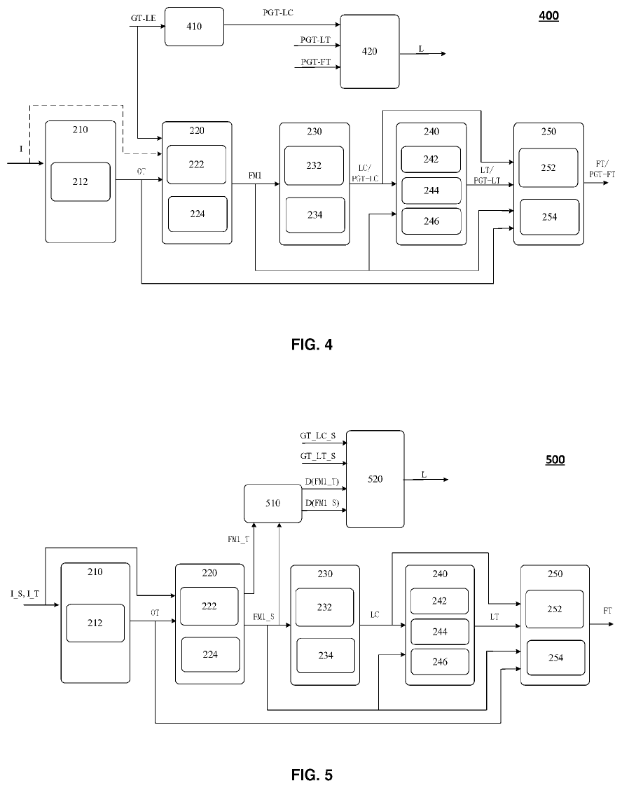

FIG. 5 is a schematic diagram of a process for training a neural network model according to one embodiment. The training process is described in FIG. 5 using the model structure shown in FIG. 2B as an example. The process described also applies to the model structures shown in FIGS. 2A and 2C.

In the embodiment shown in FIG. 5, domain adaptation (DA) is used to train the NN model in the target domain T. The training data in the source domain S comprises the ground truth GT_LT_S of the lane topology, and optionally comprises the ground truth GT_LC_S of the lane centerline. Based on the training data in the source domain S, an NN model, such as the NN model shown in FIG. 2A to 2C, may be trained in the source domain S. Due to variations in factors such as camera settings, vehicle type, and geographical region, the NN model trained in the source domain cannot be accurately processed in the target domain. In this embodiment, the training data in the source domain is transferred to the target domain by DA to train the NN model in the target domain. For example, the source domain (first domain) and the target domain (second domain) may correspond to two different regions, such as two countries, two cities, two districts, or two smaller regions.

According to one embodiment, the road traffic feature extraction module 220 generates feature graphs FM1_S and FM1_T based on the source domain image I_S and the target domain image I_T, respectively. The discriminator 510 generates domain discriminants D(FM1_S) and D(FM1_T) based on the feature graphs FM1_S and FM1_T, which are, for example, the probabilities that a feature is determined to belong to the source domain or the target domain. The loss module 520 may generate a loss related to DA based on the domain discriminants D(FM1_S) and D(FM1_T), which may also be called adversarial loss, for example, L_{adv}=−( [symbol] ₓ_{ₛ}_{~p}_{ₛ}[log D(xₛ)]+ [symbol] ₓ_{ₜ}_{~p}_{ₜ}[log(1−D(xₜ))]). The goal of this loss is to make the discriminator 510 unable to distinguish between the feature graphs FM1_S and FM1_T generated by the road traffic feature extraction module 220, thereby enabling the road traffic feature extraction module 220 to adapt the training data of the source domain to the target domain. It can be understood that any suitable domain-adaptive related loss can be used.

As shown in FIG. 5, the domain-adapted feature FM1_S is input to the lane centerline generation module 230, which generates the lane centerline LC accordingly, and the topology generation module 240 generates the lane topology LT. The loss module 520 may generate a lane topology-related loss L_{LT} based on the predicted lane topology LT and the ground truth lane topology GT_LT_S, and may generate a lane centerline-related loss LLC based on the predicted lane centerline LC and the ground truth lane centerline GT_LC_S.

In one embodiment, the loss module 520 may determine the loss L based on the above-mentioned loss components. For example, the loss L may be the sum of the above-mentioned loss components. It is understood that the loss L may comprise a portion of the above-mentioned losses, or it may comprise other loss components.

In one embodiment, the training processes of FIGS. 4 and 5 may be used in combination to train the NN model, for example, by alternately using the weakly supervised training of FIG. 4 and the DA training of FIG. 5. Alternatively, the domain-adapted fully annotated training data and the weakly supervised pseudo-labeled training data may be merged into a larger dataset to train the NN model.

According to various aspects of the present disclosure, the technical solution of the application utilizes information about road structure provided by ground truth data of lane boundaries and information about dynamic changes in the road environment provided by dynamic object trajectories. By using lane boundary lines and dynamic object trajectory detection results, which are more general and less sensitive to location, the lane topology prediction model is made more adaptable to the new environment. Thus, while using easily obtainable lane boundaries as weak supervision signals to train the NN model, the performance of the model prediction is guaranteed. This effectively overcomes the problem of requiring a large amount of topologically labeled data for training in the prior art and reduces the need for expensive and labor-intensive fully labeled data. Furthermore, by applying domain adaptation, the NN model can adapt to changes in camera settings, vehicle types, and geographical regions, making it highly versatile across different environments. By combining weak supervision method, dynamic object perception, and domain adaptation, a more efficient, cost-effective, and scalable solution for lane topology prediction is provided.

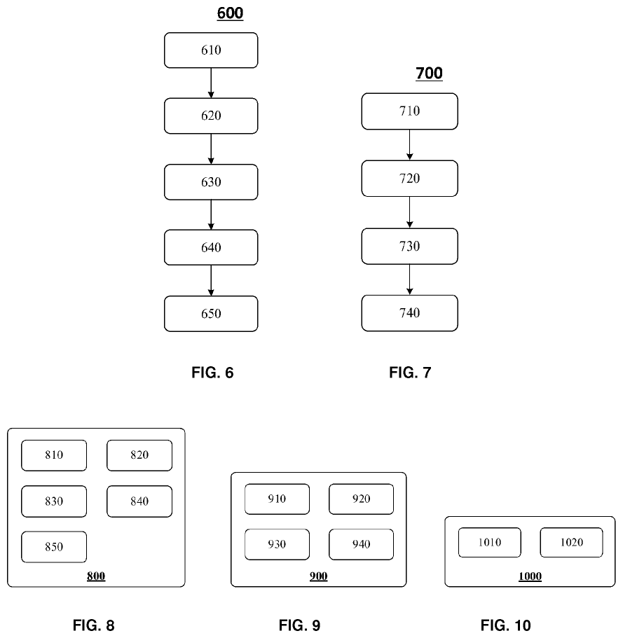

FIG. 6 is a flow chart of a method for processing road traffic according to one embodiment.

At step 610, the trajectory of an object contained in the image is detected based on the image.

At step 620, a first road traffic feature graph is generated based on at least one of the object's trajectory and the image.

At step 630, the lane centerline of the lane is generated based on the first road traffic feature graph.

At step 640, a lane topology is generated based on the lane centerline.

According to one embodiment, at step 650, the future trajectory of the vehicle is predicted based on the lane topology, the trajectory of the object, and the first road traffic feature graph.

According to one embodiment, at step 610, the boundary of a lane contained in the image is further detected based on the image. At step 620, the first road traffic feature graph is further generated based on the lane boundary.

According to one embodiment, at step 630, a heatmap is generated based on the first road traffic feature graph; and the lane centerline is determined based on the heatmap. For example, a convolutional neural network is used to generate the heatmap based on the first road traffic feature graph. For example, non-maximum suppression is applied to the heatmap to determine the position of the lane centerline.

According to one embodiment, at step 640, a lane topology is generated based on the first road traffic feature graph and the lane centerline. According to one embodiment, at step 640, a graph containing nodes and edges is constructed based on the lane centerline, wherein each node in the nodes corresponds to a lane centerline segment in the lane centerline, and each edge in the edges corresponds to a relationship between a pair of lane centerline segments in the lane centerline; the lane topology is generated based on the graph using a graph convolutional network (GCN). According to one embodiment, constructing the graph containing nodes and edges comprises: determining the node features of each node in the node and the weight of each edge in the edge based on the first road traffic feature graph and the lane centerline. For example, the node features of all nodes form a node matrix, and the weights of all edges form an adjacency matrix, the node matrix and the adjacency matrix representing the graph. According to one embodiment, determining the node features of each node in the node comprises: determining partial features related to the node in the first road traffic feature graph based on the position of each node in the node, and determining the node features of the node based on the partial features.

According to one embodiment, at step 650, a second feature graph is obtained based on the first road traffic feature graph, the lane topology and the trajectory of the object; the future trajectory of the vehicle is generated based on the second feature graph.

According to one example, the method 600 further comprises: updating the attributes of the lane centerline based on the lane topology to obtain an updated lane centerline. Obtaining the second feature graph at step 650 comprises: generating a query feature graph based on the first feature graph, generating a key feature graph based on the updated lane centerline, and generating a value feature graph based on the trajectory of the object; performing cross-attention processing based on the query feature graph, the key feature graph, and the value feature graph to obtain the second feature graph.

FIG. 7 shows a flow chart of a method for training an NN model for processing road traffic according to one example.

At step 710, a lane centerline pseudo-label is determined based on the lane boundary label in the first training set, wherein the first training set comprises an image and the lane boundary label contained in the image.

At step 720, a lane topology pseudo-label is generated based on the lane centerline pseudo-label.

At step 730, the NN model processes the image in the first training set by combining the method described in FIGS. 2A to 6 to predict the lane centerline and lane topology of the lanes contained in the image, as well as the trajectories of objects contained in the image.

At step 740, the learning parameters of the NN model are updated based on the lane centerline pseudo-label, the lane topology pseudo-label, the predicted lane centerline, and the predicted lane topology.

According to one embodiment, the NN model comprises a feature extraction module 220, a lane centerline prediction model 230, a lane topology prediction model 240, and an optional vehicle trajectory prediction model 250, as described in conjunction with FIGS. 2A to 6.

According to one embodiment, at step 720, a future trajectory pseudo-label for the vehicle is determined based on the lane topology pseudo-label. At step 730, the NN model processes the image in the first training set by combining the method described in FIGS. 2A to 6 to predict the future trajectory of the vehicle. At step 740, the learning parameters of the NN model are also updated based on the future trajectory pseudo-label and the predicted future trajectory. According to one embodiment, at step 740, the learning parameters of the NN model are also updated based on the predicted trajectory of the object.

According to one embodiment, determining the lane centerline pseudo-label at step 720 comprises: calculating the midpoint of the lane based on the left boundary label and the right boundary label of the lane, and using it as the lane centerline pseudo-label. For example, this pseudo-label may be used as an initial candidate for the pseudo-label in the initial stage of training.

According to one embodiment, determining the lane centerline pseudo-label at step 720 comprises: generating a first road traffic feature graph based on the trajectory of the object and the boundary labels of the lane; and generating the lane centerline pseudo-label based on the first road traffic feature graph. For example, the pseudo-label may be used in subsequent stages of training. It is understood that the pseudo-label obtained through the midpoint of the left and right boundaries and the pseudo-label obtained through the centerline generation module 230 can be used in any suitable manner, such as alternating use or merging use.

According to one embodiment, the first training set corresponds to a first domain, and the second training set corresponding to a second domain comprises an image and a lane topology label. The method 700 further comprises: processing the image from the first training set to obtain a third feature graph; processing the image from the second training set to obtain a fourth feature graph; generating a lane topology prediction based on the fourth feature graph; generating a first domain prediction by a discriminator based on the first feature graph; and generating a second domain prediction based on the second feature graph. At step 740, the learning parameters of the NN model are also updated based on the lane topology prediction, the lane topology label, the first domain prediction, and the second domain prediction.

According to one embodiment, the second training set further comprises a lane centerline label. The method 700 further comprises: generating a lane centerline prediction based on the fourth feature graph. At step 740, the learning parameters of the NN model are also updated based on the lane centerline prediction and the lane centerline label.

FIG. 8 is a block diagram of an apparatus for processing road traffic according to one embodiment.

The apparatus 800 comprises a detection module 810, a first road traffic feature extraction module 820, a centerline prediction module 830, a topology prediction module 840, and an optional trajectory prediction module 850.

According to one embodiment, the detection module 810, based on an image, detects the trajectory of an object contained in the image; the first road traffic feature extraction module 820 generates a first road traffic feature graph based on at least one of the object's trajectory and the image; the centerline prediction module 830 generates a lane centerline of the lane based on the first road traffic feature graph; and the topology prediction module 840 generates a lane topology based on the lane centerline. According to one embodiment, the trajectory prediction module 850 predicts the future trajectory of the vehicle based on the lane topology, the trajectory of the object, and the first road traffic feature graph.

According to one embodiment, the detection module 810 further detects the boundary of a lane contained in the image. The first road traffic feature extraction module 820 further generates the first road traffic feature graph based on the boundary of the lane.

According to one embodiment, the centerline prediction module 830 generates a heatmap based on the first road traffic feature graph; and determines the lane centerline based on the heatmap. For example, a convolutional neural network is used to generate the heatmap based on the first road traffic feature graph. For example, non-maximum suppression is applied to the heatmap to determine the position of the lane centerline.

According to one embodiment, the topology prediction module 840 generates a lane topology based on the first road traffic feature graph and the lane centerline. According to one embodiment, the topology prediction module 840 constructs a graph containing nodes and edges based on the lane centerline, wherein each node in the node corresponds to a lane centerline segment in the lane centerline, and each edge in the edge corresponds to a relationship between a pair of lane centerline segments in the lane centerline; the lane topology is generated based on the graph using a graph convolutional network (GCN). According to one embodiment, the topology prediction module 840 determines the node features of each node in the node and the weight of each edge in the edge based on the first road traffic feature graph and the lane centerline. According to one embodiment, the topology prediction module 840 determines the partial features related to the node in the first road traffic feature graph based on the position of each node in the node, and determines the node features of the node based on the partial features.

According to one embodiment, the trajectory prediction module 850 obtains a second feature graph based on the first road traffic feature graph, the lane topology and the trajectory of the object; the future trajectory of the vehicle is generated based on the second feature graph.

According to one embodiment, the attributes of the lane centerline are updated based on the lane topology to obtain an updated lane centerline. The trajectory prediction module 850 generates a query feature graph based on the first feature graph, generates a key feature graph based on the updated lane centerline, and generates a value feature graph based on the trajectory of the object; cross-attention processing is performed based on the query feature graph, the key feature graph, and the value feature graph to obtain the second feature graph.

FIG. 9 shows a block diagram of an apparatus for training an NN model for processing road traffic according to one example.

The apparatus 900 comprises a lane centerline pseudo-label generation module 910, a lane topology pseudo-label generation module 920, an update module 930, and an optional future trajectory pseudo-label generation module 940.

According to one embodiment, the lane centerline pseudo-label generation module 910 determines the lane centerline pseudo-label of a lane based on the lane boundary label in a first training set, wherein the first training set comprises an image and the boundary label of the lane contained in the image. The lane topology pseudo-label generation module 920 generates a lane topology pseudo-label based on the lane centerline pseudo-label. The NN model processes the image in the first training set by combining the method described in FIGS. 2A to 6 to predict the lane centerline and lane topology of the lanes contained in the image, as well as the trajectories of objects contained in the image. The update module 930 updates the learning parameters of the NN model based on the lane centerline pseudo-label, the lane topology pseudo-label, the predicted lane centerline, and the predicted lane topology.

According to one embodiment, the NN model comprises a feature extraction module 220, a lane centerline prediction model 230, a lane topology prediction model 240, and an optional vehicle trajectory prediction model 250, as described in conjunction with FIGS. 2A to 6.

According to one embodiment, the future trajectory pseudo-label generation module 940 determines the future trajectory pseudo-label of the vehicle based on the lane topology pseudo-label. The NN model processes the image in the first training set by combining the method described in FIGS. 2A to 6 to predict the future trajectory of the vehicle. The update module 930 also updates the learning parameters of the NN model based on the future trajectory pseudo-label and the predicted future trajectory. According to one embodiment, the update module 930 also updates the learning parameters of the NN model based on the predicted trajectory of the object.

According to one embodiment, the lane topology pseudo-label generation module 920 calculates the midpoint of the lane based on the left boundary label and the right boundary label of the lane, and uses it as the lane centerline pseudo-label.

According to one embodiment, the lane topology pseudo-label generation module 920 generates a first road traffic feature graph based on the trajectory of the object and the boundary labels of the lane; and generates the lane centerline pseudo-label based on the first road traffic feature graph.

According to one embodiment, the first training set corresponds to a first domain, and the second training set corresponding to a second domain comprises an image and a lane topology label. The NN model processes an image from the first training set to obtain a third feature graph; processes an image from the second training set to obtain a fourth feature graph; and generates a lane topology prediction based on the fourth feature graph. The discriminator of apparatus 900 generates a first domain prediction based on the first feature graph and a second domain prediction based on the second feature graph. The update module 930 also updates the learning parameters of the NN model based on the lane topology prediction, the lane topology label, the first domain prediction, and the second domain prediction.

According to one embodiment, the second training set further comprises a lane centerline label. The NN model generates a lane centerline prediction based on the fourth feature graph. The update module 930 also updates the learning parameters of the NN model based on the lane centerline prediction and the lane centerline label.

FIG. 10 is a block diagram of a processing apparatus according to one embodiment.

The processing apparatus or processing system 1000 comprises one or more control units or processing units 1010 that execute one or more machine-readable instructions stored or encoded in a machine-readable storage medium (i.e., the memory 1020). In one example, the processing unit 1010, when executing the program instructions, is configured to perform various operations and functions described above in connection with FIG. 1 to FIG. 9.

Those skilled in the art will understand that the apparatus 800 to 1000 may also comprise various other components, such as various communication modules, bus modules, and possible user interface modules.

According to one example, a program product, such as a non-transitory machine-readable medium, is provided. The non-transitory machine-readable medium may have instructions that, when executed by the processing unit 1010, are capable of performing various operations and functions described above in connection with FIG. 1 to FIG. 9 in various examples of the present application.

According to one example, a computer program product is provided. The computer program product comprises computer-executable instructions that, when executed by the processing unit 1010, are capable of performing various operations and functions described above in connection with FIGS. 1 to 9 in various examples of the present application.

Exemplary examples are described above with reference to the specific examples described in the accompanying drawings, but do not represent all examples that may be implemented or fall within the scope of protection of the patent claims. Throughout the present Specification, the term “exemplary” means “serving as an example, instance, or illustration” and does not imply “preferred” or “advantageous” over other examples. Specific examples comprise specific details to facilitate understanding of the described technology. However, these technologies may be implemented without these specific details. In some instances, to avoid causing difficulties in understanding the concepts of the described examples, known structures and apparatuses are shown in block diagram form.

The aforementioned description of the present application is provided to allow any person of ordinary skill in the art to implement or use the present application. Various modifications to the present application will be apparent to those of ordinary skill in the art, and the general principles defined herein may be applied to other variations without departing from the scope of protection of the present application. Therefore, the present application is not limited to the exemplary examples and designs described herein but is consistent with the broadest scope defined by the principles and novel features disclosed herein.

What is claimed is:

1. A method for processing road traffic, comprising:
detecting the trajectory of an object contained in an image;
generating a first road traffic feature graph based on at least one of the object's trajectory and the image;
generating a lane centerline of the lane based on the first road traffic feature graph; and
generating a lane topology based on the lane centerline.

2. The method according to claim 1, further comprising predicting the future trajectory of the vehicle based on the lane topology, the trajectory of the object, and the first road traffic feature graph.

3. The method according to claim 1, further comprising detecting the boundary of a lane contained in the image, wherein:
generating a first road traffic feature graph comprises further generating the first road traffic feature graph based on the boundary of the lane.

4. The method according to claim 1, wherein generating the lane centerline of the lane comprises:
generating a heatmap based on the first road traffic feature graph; and
determining the lane centerline based on the heatmap.

5. The method according to claim 1, wherein generating the lane topology comprises:
constructing a graph containing nodes and edges based on the lane centerline, wherein each node in the nodes corresponds to a lane centerline segment in the lane centerline, and each edge in the edges corresponds to a relationship between a pair of lane centerline segments in the lane centerline; and
generating the lane topology based on the graph using a graph convolutional network.

6. The method according to claim 5, wherein constructing a graph containing nodes and edges comprises determining the node features of each node in the nodes and the weight of each edge in the edges based on the first road traffic feature graph and the lane centerline.

7. The method according to claim 6, wherein determining the node features of each node in the nodes comprises determining partial features related to the node in the first road traffic feature graph based on the position of each node in the nodes, and determining the node features of the node based on the partial features.

8. The method according to claim 2, wherein predicting the future trajectory of the vehicle comprises:
obtaining a second feature graph based on the first road traffic feature graph, the lane topology, and the trajectory of the object; and
generating the future trajectory of the vehicle based on the second feature graph.

9. The method according to claim 8, further comprising updating the attributes of the lane centerline based on the lane topology to obtain an updated lane centerline, wherein obtaining the second feature graph comprises:
generating a query feature graph based on the first feature graph, generating a key feature graph based on the updated lane centerline, and generating a value feature graph based on the trajectory of the object; and
performing cross-attention processing based on the query feature graph, the key feature graph, and the value feature graph to obtain the second feature graph.

10. A method for training a neural network (NN) model for processing road traffic, comprising:
based on a boundary label for a lane in a first training set, determining a lane centerline pseudo-label for the lane, wherein the first training set comprises an image and the boundary label of the lane contained in the image;
generating a lane topology pseudo-label based on the lane centerline pseudo-label;
processing the image in the first training set using the NN model through the method according to claim 1 to predict a lane centerline and a lane topology of the lane contained in the image, as well as trajectory of an object contained in the image; and
updating learning parameters of the NN model based on the lane centerline pseudo-label, the lane topology pseudo-label, the predicted lane centerline, and the predicted lane topology.

11. The method according to claim 10, further comprising:
determining a future trajectory pseudo-label for the vehicle based on the lane topology pseudo-label; and
processing the image in the first training set using the NN model to predict the future trajectory of the vehicle,
wherein updating the learning parameters of the NN model comprises further updating the learning parameters of the NN model based on the future trajectory pseudo-label and the predicted future trajectory.

12. The method according to claim 10, wherein updating the learning parameters of the NN model comprises further updating the learning parameters of the NN model based on the predicted trajectory of the object.

13. The method according to claim 10, wherein determining a lane centerline pseudo-label for the lane comprises:
calculating the midpoint of the lane based on the side boundary labels of the lane, as the lane centerline pseudo-label.

14. The method according to claim 10, wherein determining a lane centerline pseudo-label for the lane comprises:
generating a first road traffic feature graph based on the trajectory of the object and the boundary label of the lane; and
generating the lane centerline pseudo-label of the lane based on the first road traffic feature graph.

15. The method according to claim 10, wherein the first training set corresponds to a first domain, and the second training set corresponding to a second domain comprises an image and a lane topology label, the method further comprising:
processing an image from the first training set to obtain a third feature graph;
processing an image from the second training set to obtain a fourth feature graph;
generating a lane topology prediction based on the fourth feature graph; and
generating a first domain prediction by a discriminator based on the third feature graph, and generating a second domain prediction based on the fourth feature graph;
wherein, updating the learning parameters of the NN model comprises updating the learning parameters of the NN model based on the lane topology prediction, the lane topology label, the first domain prediction, and the second domain prediction.

16. The method according to claim 15, wherein the second training set further comprises a lane centerline label, and the method further comprising generating a lane centerline prediction based on the fourth feature graph,
wherein updating the learning parameters of the NN model comprises updating the learning parameters of the NN model based on the lane centerline prediction and the lane centerline label.

17. An apparatus for processing road traffic, comprising:
a detection module configured to detect the trajectory of an object contained in an image;
a first road traffic feature extraction module configured to generate a first road traffic feature graph based on at least one of the object's trajectory and the image;
a centerline prediction module configured to generate a lane centerline of the lane based on the first road traffic feature graph; and
a topology prediction module configured to generate a lane topology based on the lane centerline.

18. The apparatus according to claim 17, further comprising:
a trajectory prediction module configured to predict the future trajectory of the vehicle based on the lane topology, the trajectory of the object, and the first road traffic feature graph.

19. An apparatus for training an NN model for processing road traffic, comprising:
a lane centerline pseudo-label generation module configured to determine, based on a boundary label for a lane in a first training set, a lane centerline pseudo-label for the lane, wherein the first training set comprises an image and the boundary label of the lane contained in the image;
a lane topology pseudo-label generation module configured to generate a lane topology pseudo-label based on the lane centerline pseudo-label;
wherein the NN model processes the image in the first training set using the method according to claim 1 to predict a lane centerline and a lane topology of the lane contained in the image; and
an update module configured to update learning parameters of the NN model based on the lane centerline pseudo-label, the lane topology pseudo-label, the predicted lane centerline, and the predicted lane topology.

20. An apparatus for determining road traffic topological relationships, comprising:
one or more processors; and
one or more memories storing computer-executable instructions that, when executed by the one or more processors, perform the method according to claim 1.

21. A machine-readable storage medium storing executable instructions that, when executed, cause one or more processors to perform the method according to claim 1.

22. A computer program product comprising executable instructions that, when executed, cause one or more processors to perform the method according to claim 1.
